(19) United States
(12) Patent Application Publication
(10) Pub. No.: US 2025/0296245 A1
(43) Pub. Date: Sep. 25, 2025

(54) MODULAR CONNECTOR FOR ROBOTIC TOOL SYSTEM AND ROBOTIC TOOL SYSTEM THEREOF

(71) Applicant: L&T TECHNOLOGY SERVICES LIMITED, Chennai (IN)

(72) Inventors: JASON HOVEY, Bradford, IL (US); KEEGAN SULLIVAN, Peoria, IL (US)

(21) Appl. No.: 18/655,669

(22) Filed: May 6, 2024

(30) Foreign Application Priority Data
Mar. 21, 2024 (IN) 202441022019

(51) Int. Cl. B25J 15/00; B23K 37/02; B25J 11/00

(52) U.S. Cl. CPC B25J 15/0061; B23K 37/0241; B25J 11/005

(57) ABSTRACT

The present disclosure relates to a modular connector for a robotic tool system. The modular connector comprises a first plate, a bracket, a second plate and a clamping mechanism. The clamping mechanism includes at least two fixed clamping features and an at least one movable clamping feature positioned opposite to the at least two fixed clamping features. A tool is adapted to be received between the at least two fixed clamping features and the at least one movable clamping feature, such that movement of the at least one movable clamping feature relative to the at least two fixed clamping features facilitates clamping of the tool on the second plate of the modular connector. The modular connector facilitates easy and quick mounting of the tool of variable shape and size of the tool.

### TECHNICAL FIELD

This disclosure relates generally to a robotic tool system, and more particularly to a modular connector for a robotic tool system.

### BACKGROUND

Now-a-days, the industries are implementing automation in order to increase the production or manufacturing rate of articles. The industries may be defined as any article manufacturing industry, for instance—vehicle manufacturing industries and likewise. The automation may generally include utilization of robotic units, for example—industrial robots that are dedicated to perform specific operations at a faster speed and in a more precise manner when compared with the operations performed manually by industrial workers. The industrial robots may hereinafter be referred to as “robots” generally comprises a control unit and a mechanical unit which is electrically connected to the control unit. The control unit is configured to store and process predefined algorithms in order to perform functioning of the mechanical units. The mechanical units may include a robotic arm configured to facilitate mounting of specific tools to perform specific functions.

Conventionally, robotic welding systems consist of an industrial robot and a robotic welding machine. These robotic welding machines are purpose built to interface with a robot and have no provisions for a human to use the welding machine manually. Similarly, manual welding machines that are intended for a human to use are not configurable for a robot to use. This lack of overlap means that if an industrial process requires welding, a choice must be made between robot welding and manual welding, and this choice is then solidified in the purchase, setup, and upkeep of either a manual welding machine or a robotic welding machine. This distinction between manual and robotic welding requires additional capital and labor investment, and results in unused equipment when a manual process switches to a robotic process or vice versa, such as when higher repeatability is required or throughput requirements increase.

Additionally, existing welding robots may not comprise a removably installed welding tool. This lack of modularity means that existing welding robots are not configurable to perform tasks other than welding. Existing non-welding robots may be configured to perform welding operations, but the process is intrusive and time consuming, meaning once the robot is configured for welding or non-welding, it requires a large time investment to change the robot's configuration. In an environment where robots are limited, or the welding process is not expected to be a long term installation, existing solutions require either the purchase of a dedicated welding robot, or the configuration and deconfiguration of a non-welding robot to perform a welding task.

The two shortcomings listed above become amplified in a research and development setting, where adaptability and flexibility are of high importance, and where a manual welding machine may be commonplace, but a robotic welding machine may not be. In these settings, the ability to quickly combine and de-combine a manual welding machine with a non-welding robot saves on time configuring a robot, capital investment in redundant welding machines, and storage space on machines that may not be frequently used.

The present disclosure is directed to overcome one or more limitations stated above or any other limitation associated with the prior arts.

### SUMMARY OF THE INVENTION

One or more shortcomings of the prior art are overcome by a modular connector for a robotic tool system as disclosed and additional advantages are provided through the constructional features of the modular connector as described in the present disclosure.

Additional features and advantages are realized through the techniques of the present disclosure. Other embodiments and aspects of the disclosure are described in detail herein and are considered a part of the claimed disclosure.

In one non-limiting embodiment of the present disclosure, a modular connector for a robotic tool system is disclosed. The modular connector may include a first plate and a bracket configured to removably connect the first plate with a second plate. The second plate may comprise a clamping mechanism configured to facilitate clamping of a tool on the second plate of the modular connector. The clamping mechanism may comprise at least two fixed clamping features and an at least one movable clamping feature positioned opposite to the at least two fixed clamping features. The tool is adapted to be received between the at least two fixed clamping features and the at least one movable clamping feature, such that movement of the at least one movable clamping feature relative to the at least two fixed clamping features facilitates clamping of the tool on the second plate of the modular connector.

In an embodiment, the clamping mechanism may comprise a guide member adapted to be slidably received in a slot defined in the second plate.

In an embodiment, the guide member is rigidly connected to the at least one movable clamping feature, such that movement of the guide member along the slot facilitates movement of the at least one movable clamping feature.

In an embodiment, the guide member is defined having a T-shaped structure adapted to be received in the slot having a step-profile corresponding to the T-shape structure of the guide member.

In an embodiment, the clamping mechanism may comprise an actuating screw configured to be engaged with a threaded through-bore defined in a bottom wall of the second plate. The actuating screw may comprise a tail end that abuts with a bottom face of the guide member, such that rotation of the actuating screw facilitates movement of the guide member along the slot and simultaneously facilitates movement of the at least one movable clamping feature.

In an embodiment, the second plate is removably mounted on the first plate at a predefined angle or relative position, depending on structure of the bracket.

In an embodiment, the tool is a cylindrical tool, preferably a manual weld gun of a manual welding machine.

In an embodiment, the at least two fixed clamping features and the at least one movable clamping feature have cylindrical structure defined with a concave profile at centre portion of respective clamping features to facilitate firm gripping of the tool.

In an embodiment, the modular connector may comprise a shield removably mounted on a front wall of the second plate.

In an embodiment, the bracket is configured to be mounted on the first plate at multiple positions, depending on clearance requirements and operation to be performed by the tool.

In an embodiment, the first plate is defined with a plurality of first holes adapted to receive first fasteners to facilitate removable mounting of the first plate on a robotic arm of the robotic tool system.

In an embodiment, the robotic tool system may comprise a control unit configured to be electrically connected to the tool to facilitate automated operation of the tool.

In an embodiment, the bracket is configured to connect the first plate with the second plate to form an L-shaped structure of the modular connector.

In another embodiment, a robotic tool system is disclosed. The robotic tool system may include a robotic arm configured to perform automated operations. The robotic tool system may comprise a modular connector configured to facilitate mounting of a tool on the robotic arm. The modular connector may comprise a first plate and a bracket configured to removably connect the first plate with a second plate. The second plate may comprise a clamping mechanism configured to facilitate clamping of the tool on the second plate of the modular connector. The clamping mechanism may comprise at least two fixed clamping features and an at least one movable clamping feature positioned opposite to the at least two fixed clamping features. The tool is adapted to be received between the at least two fixed clamping features and the at least one movable clamping feature, such that movement of the at least one movable clamping feature relative to the at least two fixed clamping features facilitates clamping of the tool on the second plate of the modular connector.

In an embodiment, the first plate is defined with a plurality of first holes adapted to receive first fasteners to facilitate removable mounting of the first plate on the robotic arm.

In an embodiment, the clamping mechanism may comprise a guide member adapted to be slidably received in a slot defined in the second plate.

In an embodiment, the guide member is rigidly connected to the at least one movable clamping feature, such that movement of the guide member along the slot facilitates movement of the at least one movable clamping feature.

In an embodiment, the clamping mechanism may comprise an actuating screw configured to be engaged with a threaded through-bore defined in a bottom wall of the second plate. The actuating screw may comprise a tail end that abuts with a bottom face of the guide member, such that rotation of the actuating screw facilitates movement of the guide member along the slot and simultaneously facilitates movement of the at least one movable clamping feature.

In an embodiment, the robotic tool system may comprise a control unit configured to be electrically connected to the tool to facilitate automated operation of the tool.

In an embodiment, the bracket is configured to connect the first plate with the second plate to form an L-shaped structure of the modular connector.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

The novel features and characteristics of the disclosure are set forth in the appended description. The disclosure itself, however, as well as a preferred mode of use, further objectives, and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 illustrates a left perspective view of modular connecter attached with a tool, in accordance with an embodiment of the present disclosure;

FIG. 2 illustrates a right perspective view of the modular connector of FIG. 1, in accordance with an embodiment of the present disclosure;

FIG. 3 illustrates a side view of the modular connector of FIG. 1, in accordance with an embodiment of the present disclosure;

FIG. 4 illustrates a top perspective view of the modular connector of FIG. 1 attached with a shield, in accordance with an embodiment of the present disclosure;

FIG. 5 illustrates an exploded view of the modular connector of FIG. 4, in accordance with an embodiment of the present disclosure; and

FIG. 6 illustrates a left perspective view of the modular connector of FIG. 1 attached to a robotic arm of a robotic tool system, in accordance with an another embodiment of the present disclosure.

The figures depict embodiments of the disclosure for purposes of illustration only. One skilled in the art will readily recognize from the following description that alternative embodiments of the assembly illustrated herein may be employed without departing from the principles of the disclosure described herein.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the spirit and the scope of the disclosure.

The terms “comprises”, “comprising”, or any other variations thereof, are intended to cover a non-exclusive inclusion, such that a system that comprises a list of components does not include only those components but may include other components not expressly listed or inherent to such assembly or system. In other words, one or more components in a system proceeded by “comprises . . . a” does not, without more constraints, preclude the existence of other acts or additional acts in the method.

In an embodiment, a modular connector for a robotic tool system is disclosed. The modular connector is configured to provide provisions that facilitate mounting of different kind of tools, preferably cylindrical tools and more preferably manual weld guns on to a robotic arm of the robotic tool system. The modular connector also facilitates mounting of the tool in different orientations depending on clearance requirements and operation to be performed by the tool. The modular connector is also provided with provisions to facilitate removable mounting of the modular connector on the robotic arm of the robotic tool system. The modular connector may comprise provisions that easy and quick mounting of the tool on the robotic arm of the robotic tool system. Further, the modular connector comprising the provisions to facilitate mounting of different kind of tools facilitate diversity of operations that can be performed by a same robotic arm of the robotic tool system. The modular connector may alternatively be defined as a connector, adaptor, connecting unit, tool mounting unit and likewise.

In an embodiment, the modular connector may hereinafter be referred as a “connector” and the robotic tool system may hereinafter be referred as a “system”. The modular connector may comprise a first plate and a bracket configured to removably connect the first plate with a second plate. The bracket is configured to removably connect the first plate with the second plate to form an “L-shaped” structure of the modular connector. The first plate and the second plate may be defined having a cuboidal shaped structure, but not limited to the same. Alternatively, the first plate and the second plate may be defined having a circular shaped structure, polygonal shaped structure or likewise. The second plate may comprise a clamping mechanism configured to facilitate clamping of a tool on the second plate of the modular connector. The clamping mechanism may comprise at least two fixed clamping features and an at least one movable clamping feature positioned opposite to the at least two fixed clamping features. The clamping features may alternatively be defined as clamps, clamping units, clamping members, gripping members, grippers, jaws, claws and likewise.

The tool is adapted to be received between the at least two fixed clamping features and the at least one movable clamping feature, such that movement of the at least one movable clamping feature relative to the at least two fixed clamping features facilitates clamping of the tool on the second plate of the modular connector. The clamping mechanism may alternatively include more than two fixed clamping features and more than one movable clamping features, depending on shape and size of the tool to be clamped on the second plate of the modular connector.

The at least two fixed clamping features and the at least one movable clamping feature have cylindrical structure defined with a concave profile at centre portion of respective clamping features to facilitate firm gripping of the tool. The at least one movable clamping feature is defined having a size greater than size of the at least two fixed clamping features. The at least two fixed clamping features and the at least one movable clamping feature may be defined having a V-shaped structure to facilitate firm gripping of the tool. The at least two fixed clamping features and the at one movable clamping feature may alternatively be defined having a specific shape and structure to facilitate firm gripping of tools having similar shape and size.

In an exemplary embodiment, the clamping mechanism may comprise a guide member adapted to be slidably received in a slot defined in the second plate. The guide member is rigidly connected to the at least one movable clamping feature, such that movement of the guide member along the slot facilitates movement of the at least one movable clamping feature. The guide member may be rigidly connected to the at least one movable clamping feature by a mounting means, for example—fasteners, but not limited to the same. Alternatively, the guide member may be rigidly connected to the at least one movable clamping feature through snap-fit mechanism, threaded connection means and likewise. In an embodiment, the guide member is defined having a T-shaped structure adapted to be received in the slot having a step-profile corresponding to the T-shape structure of the guide member. The guide member and corresponding slot may also have a dovetail or trapezoidal shape, or any other profile where a side of the guide member and corresponding slot closer to the at least one movable clamping feature is narrower than any area of the guide member and corresponding slot farther from the at least one clamping feature, and that permits translational motion. The clamping mechanism may further comprise an actuating screw configured to be engaged with a threaded through-bore defined in a bottom wall of the second plate. The actuating screw may comprise a tail end that abuts with a bottom face of the guide member, such that rotation of the actuating screw facilitates movement of the guide member along the slot and simultaneously facilitates movement of the at least one movable clamping feature. Alternatively, the clamping mechanism may include any threaded element that is configured to be rotatably engaged with the threaded through bore of the second plate to facilitate linear or sliding movement of the guide member along the slot. Additionally, the clamping mechanism may utilize an externally powered actuator, for example hydraulic or pneumatic cylinders, to move the guide member and the at least one clamping feature. Further, the clamping mechanism may utilize a system of linkages that are rotatably connected to each other and to the second plate, where these linkages move in a way to advance or retract the guide member and the at least one clamping feature along the corresponding slot.

In an embodiment, the second plate is removably mounted on the first plate at a predefined angle, depending on structure of the bracket. The structure of the bracket may facilitate mounting of the second plate on the first plate at different orientations and thereby facilitate mounting of the tool on the second plate in different orientations depending on the clearance requirements and kind of operation to be performed by the tool. The modular connector may also comprise a shield removably mounted on a front wall of the second plate to protect components of the robotic tool system as well as worker in proximity to the robotic tool system from unintentional situations, for example—welding sparks generated while performing welding operation by the tool, i.e., manual weld gun, mounting on the modular connector of the system.

In another embodiment, the robotic tool system is disclosed. The robotic tool system may comprise a robotic arm configured to perform automated operations. The robotic tool system may comprise a modular connector configured to facilitate mounting of a tool on the robotic arm. The modular connector may comprise a first plate and a bracket configured to removably connect the first plate with a second plate. The second plate may comprise a clamping mechanism configured to facilitate clamping of the tool on the second plate of the modular connector. The clamping mechanism may comprise at least two fixed clamping features and an at least one movable clamping feature positioned opposite to the at least two fixed clamping features. The tool is adapted to be received between the at least two fixed clamping features and the at least one movable clamping feature, such that movement of the at least one movable clamping feature relative to the at least two fixed clamping features facilitates clamping of the tool on the second plate of the modular connector.

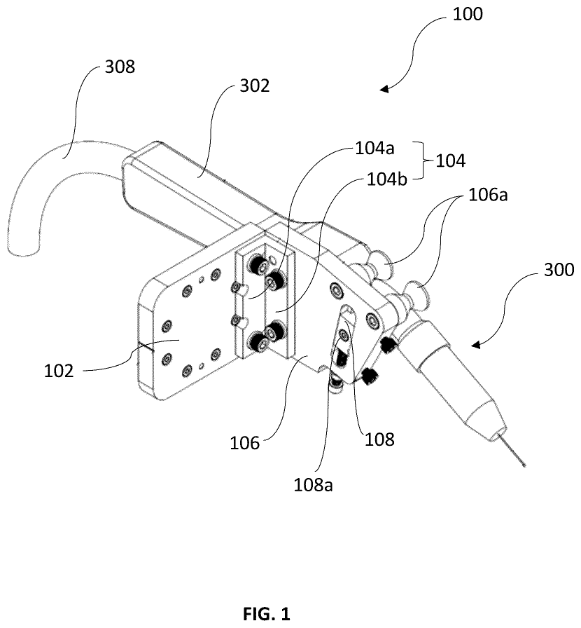

The following paragraphs describe the present disclosure with reference to FIGS. 1 to 6. In the figures, the same element or elements which have similar functions are indicated by the same reference signs.

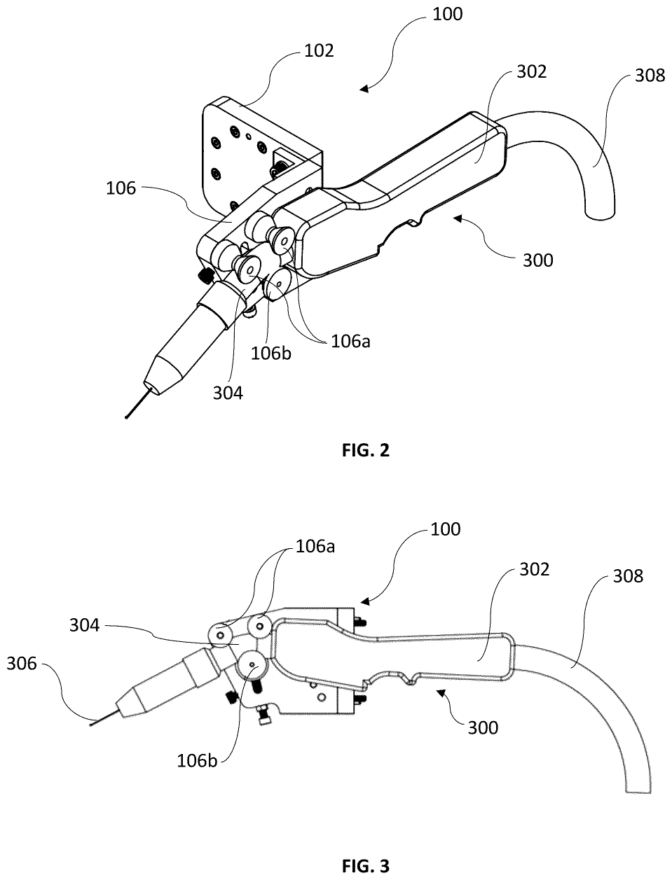

Referring now to FIG. 1 and FIG. 2, perspective views of a modular connector (100) is illustrated, in accordance with an embodiment of the present disclosure. As will be understood, the modular connector (100) may be meant for a connector associated with a robotic tool system (200) that facilitate mounting of a tool (300) on a robotic arm (202) of the robotic tool system (200). The modular connector (100) may alternatively be referred as a “connector” and the robotic tool system may alternatively be referred as a “system”. The connector (100) may comprise provisions to facilitate removable mounting of the tool (300) on the system (200), particularly on the robotic arm (202) of the system (200). The tool (300) may be defined as any tool that is electrically connected to a control unit (not shown in FIGS.) of the system (200) to perform a specific function.

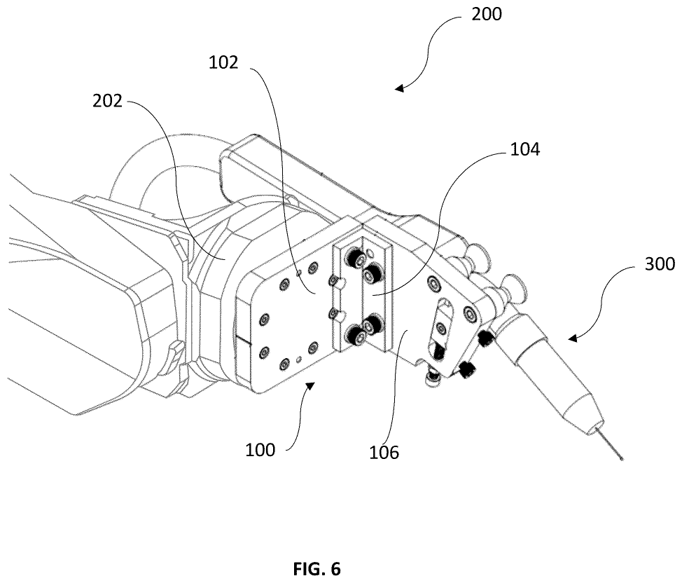

In an exemplary embodiment, the tool (300) is a cylindrical tool, preferably a manual weld gun, as shown in FIGS. 1-6. The modular connector (100) provides modularity in clamping of different kind of tools (300) of similar shape, size and structure on the robotic arm (202) of the system (200). The robotic tool system (200) comprising the robotic arm (202) mounted with the modular connector (100) and the tool (300) is depicted in FIG. 6. The robotic tool system (200) may comprise the control unit configured to be electrically connected to the tool (300) to facilitate automated operation of the tool (300). The robotic tool system (200) facilitates movement of the robotic arm (202) in distinct positions such that, movement of the robotic arm (202) depends on an algorithm feed into the control unit of the system (200). The movement of the robotic arm (202) facilitates simultaneous movement of the tool (300) in order to perform desired operation at specific co-ordinates or locations of a work piece.

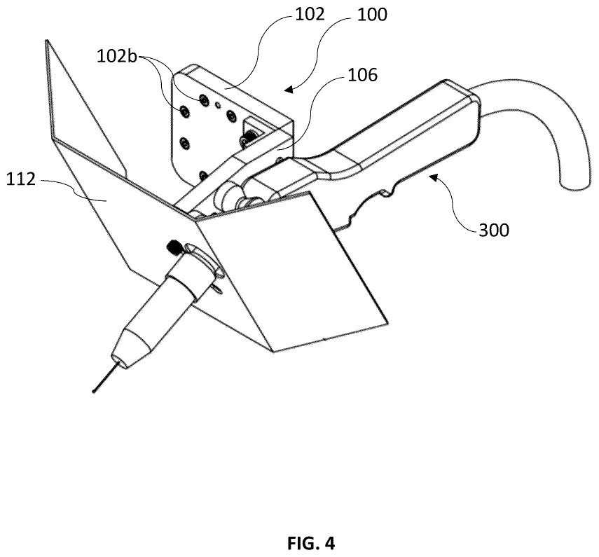

Referring to FIG. 2 and FIG. 3, the tool (300) defined as the manual weld gun may comprise a handle portion (302), a body portion (304) and a cable (308), such that the cable (308) is configured to electrically connect the manual weld gun with the robotic tool system (200). The handle portion (302) facilitates griping of the manual weld gun or tool (300) during manual operation of the manual weld gun. The body portion (304) of the manual weld gun is configured to be clamped on the modular connector (100) to facilitate movement of the weld gum simultaneously with movement of the robotic arm (202) of the system (200). The manual weld gun may comprise an electrode (306) to perform welding operation on the workpiece. The electrode (306) is adapted to be received and secured in the body portion (304) of the manual weld gun, as shown in FIG. 3. Alternatively, the tool (300) may be defined as any other tool unit that is configured to perform a specific operation.

The modular connector (100) is configured to facilitate mounting of the tool (300) on the robotic arm (202). The modular connector (100) may comprise a first plate (102), a bracket (104) and a second plate (106), as shown in FIG. 1. The first plate (102) and the second plate (106) may be defined as planar metal sheets with a considerable thickness. The first plate (102) and the second plate (106) may be defined having any shape and structure. In an exemplary embodiment, the first plate (102) and the second plate (106) may be defined having a cuboidal structure, but not limited to the same. Alternatively, the first plate (102) and the second plate (106) may be defined having a circular, oval shaped structure and likewise. The bracket (104) may be defined as an angle bracket configured to connect the second plate (106) with the first plate (102). The bracket (104) is configured to removably connect the first plate (102) with the second plate (106). The bracket (104) is configured to connect the second plate (106) at any predefined angle relative to the first plate (102), which depends on the shape and structure of the bracket (104). The bracket (104) is configured to be mounted on the first plate (102) at multiple positions, depending on clearance requirements and operation to be performed by the tool (300).

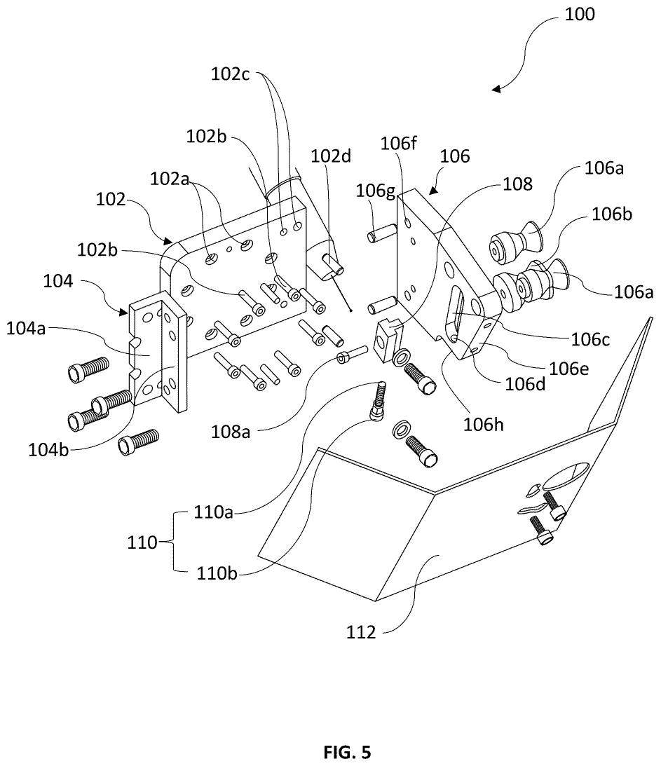

The first plate (102) may be defined with a plurality of first holes (102a) adapted to receive first fasteners (102b), as shown in FIG. 5. The first fasteners (102b) are configured to facilitate removable mounting of the first plate (102) on the robotic arm (202) of the robotic tool system (200) at a predefined location. The first plate (102) may be defined with a plurality of second holes (102c) adapted to receive second fasteners (102d) configured to facilitate removable mounting of the bracket (104) on the first plate (102). The positioning of the plurality of second holes (102c) facilitates mounting of the bracket (104) at any predefined location on the first plate (102), depending on the shape size of the work piece. The first fasteners (102b) and the second fasteners (102d) may be defined as threaded screws comprise a plurality of outer threads configured to engage with a threads defined in the plurality of first holes (102a) and the plurality of second holes (102c).

The second plate (106) may be defined with a plurality of third holes (106f) adapted to receive third fasteners (106g) configured to connect the bracket (104) with the second plate (106). The bracket (104) may comprise a first flange (104a) and a second flange (104b), as shown in FIG. 5. The first flange (104a) may be defined with first apertures adapted to receive second fasteners (102d) to facilitate mounting of the bracket (104) on the first plate (102). In the same manner, the second flange (104b) may be defined with second apertures adapted to receive third fasteners (106g) configured to connect the bracket (104) with the second plate (106). The first flange (104a) and the second flange (104b) are integrally connected with each other to form a unitary structure of the bracket (104), preferably an L-shaped structure of the bracket (104). Alternatively, the first flange (104a) and the second flange (104b) is connected to each other at any predefined angle to vary angular orientation of the second plate (106) with respect to the first plate (102). The shape and structure of the bracket (104) may facilitate in defining a particular orientation of the second plate (106) relative to the first plate (102) and thereby provide a particular orientation of the tool (300) relative to the first plate (102) or the robotic arm (202). The bracket (104) is configured to connect the first plate (102) with the second plate (106) to form an L-shaped structure of the modular connector (100).

In an exemplary embodiment, the modular connector (100) comprises a clamping mechanism configured to facilitate clamping of a tool (300) on the second plate (106) of the modular connector (100). The clamping mechanism may include at least two fixed clamping features (106a) and an at least one movable clamping feature (106b) positioned opposite to the at least two fixed clamping features (106a). The at least two fixed clamping features (106a) and the at least one movable clamping feature (106b) may alternatively be defined as clamps, jaws, claws, clamping members, clamping elements and likewise. The at least two fixed clamping features (106a) are defined having shape and structure identical to each other, but not limited to the same. Also, the at least one movable clamping feature (106b) may be defined having a size greater than size of the at least two fixed clamping features (106a). The tool (300) is adapted to be received between the at least two fixed clamping features (106a) and the at least one movable clamping feature (106b), such that movement of the at least one movable clamping feature (106b) relative to the at least two fixed clamping features (106a) facilitates clamping of the tool (300) on the second plate (106) of the modular connector (100). In an exemplary embodiment, the body portion (304) of the tool (300) is configured to be received in between the at least two fixed clamping features (106a) and the at least one movable clamping feature (106b), as shown in FIG. 3.

In an embodiment, the at least two fixed clamping features (106a) and the at least one movable clamping feature (106b) have cylindrical structure defined with a concave profile at centre portion of respective clamping features. The concave profile of the clamping features (106a, 106b) facilitate in providing firm gripping of the tool (300), particularly the body portion (304) of the tool (300). The concave profile may also result in firm gripping of the body portion (304) of the tool (300) having different shapes, particularly cylindrical shaped tool (300). Referring to FIG. 4 and FIG. 5, the modular connector (100) may comprise a shield (112) removably mounted on a front wall (106e) of the second plate (106). The shield (112) is provided to prevent damages or accidents during operation of the tool (300), preferably while performing welding operation by the manual weld gun as tool. The shield (112) is mounted on the second plate (106) by using any existing connecting means, for example—fasteners, snap fits and likewise.

Once again referring to FIG. 5, the clamping mechanism may comprise a guide member (108) adapted to be slidably received in a slot (106c) defined in the second plate (106). The guide member (108) is rigidly connected to the at least one movable clamping feature (106b), such that movement of the guide member (108) along the slot (106c) facilitates movement of the at least one movable clamping feature (106b). The guide member (108) is connected to the at least one movable clamping feature (106b) by means of a guide screw (108a). The guide screw (108a) facilitates removable connection between the guide member (108) and the at least one movable clamping feature (106b) and facilitate ease in servicing/maintenance of the modular connector (100). The clamping mechanism may comprise more than one guide member (108) depending on number of the movable clamping features (106b). Alternatively, a single guide member (108) may be provided with provisions to rigidly connect more than one movable clamping feature (106b).

In an exemplary embodiment, the guide member (108) is defined having a T-shaped structure adapted to be received in the slot (106c) having a step-profile corresponding to the T-shaped structure of the guide member (108). Alternatively, the shape and structure of the guide member (108) may be defined complimentary to the corresponding slot (106c) defined in the second plate (106). The clamping mechanism may further comprise an actuating screw (110) configured to be engaged with a threaded through-bore (106d) defined in a bottom wall (106h) of the second plate (106). The actuating screw (110) comprises a tail end (110a) that abuts with a bottom face of the guide member (108), such that rotation of the actuating screw (110) facilitates movement of the guide member (108) along the slot (106c) and simultaneously facilitates movement of the at least one movable clamping feature (106b). The bottom face of the guide member (108) may be defined as a face adjacent to the bottom wall (106h) of the second plate (106). Alternatively, the bottom wall (106h) may be attached with a nut on an outer surface of the bottom wall (106h), such that the nut rotatably receive the actuating screw (110) to facilitate movement of the guide member (108) along the slot (106c). The nut may be attached to the bottom wall (106h) by existing fixed attaching means, for example—welding and likewise. The first fasteners (102b), the second fasteners (102d), the third fasteners (106g) and any other fastener utilized in the system (200) may be provided with washers in order to absorb vibrations during operating conditions of the tool (300).

In yet another embodiment, a method for attaching a tool on the robotic arm of the robotic tool system is disclosed. The method comprises initial steps of mounting the first plate (102) of the modular connector (100) on a free end of the robotic arm (202) of the system (200) by first fasteners (102b). The step includes mounting the bracket (104) on the first plate (102) by the second fasteners (102d). The step includes mounting the second plate (106) on the bracket (104) by the third fasteners (106g) at a predefined position or orientation, depending on clearance requirements and operation to be performed by the tool. The step includes rotating the actuating screw (110) in a first direction to facilitate movement of the guide member (108) and thereby movement of the at least one movable clamping feature (106b) in a direction opposite to the at least two fixed clamping features (106a). The step includes placing the tool (300) in between the at least two fixed clamping features (106a) and the at least one movable clamping feature (106b). Once, the tool (300) is placed in the desired position, the user or operator may rotate the actuating screw (110) in a direction opposite to the first direction to facilitate movement of the guide member (108) and thereby simultaneous movement of the at least one movable clamping feature (106b) towards the at least two fixed clamping features (106a) to facilitate firm gripping of the tool (300) between the clamping features (106a, 106b).

The above subject matter discloses a modular connector for a robotic tool system configured to provide provisions that facilitate mounting of different kind of tools, preferably cylindrical tools and more preferably manual weld guns on to a robotic arm of the robotic tool system. The modular connector also facilitates mounting of the tool in different orientations depending on clearance requirements and operation to be performed by the tool. The modular connector is also provided with provisions to facilitate removable mounting of the modular connector on the robotic arm of the robotic tool system. The modular connector comprises provisions that facilitate easy and quick mounting of the tool on the robotic arm of the robotic tool system.

It is intended that the disclosure and examples be considered as exemplary only, with a true scope and spirit of disclosed embodiments being indicated by the following claims.

### EQUIVALENTS

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A modular connector for a robotic tool system, comprising:
a first plate;
a bracket configured to removably connect the first plate with a second plate, wherein the second plate comprises:
a clamping mechanism configured to facilitate clamping of a tool on the second plate of the modular connector; the clamping mechanism comprises:
at least two fixed clamping features and an at least one movable clamping feature positioned opposite to the at least two fixed clamping features, wherein the tool is adapted to be received between the at least two fixed clamping features and the at least one movable clamping feature, such that movement of the at least one movable clamping feature relative to the at least two fixed clamping features facilitates clamping of the tool on the second plate of the modular connector.

2. The modular connector of claim 1, wherein the clamping mechanism comprises a guide member adapted to be slidably received in a slot defined in the second plate; and wherein the guide member is rigidly connected to the at least one movable clamping feature, such that movement of the guide member along the slot facilitates movement of the at least one movable clamping feature.

3. The modular connector of claim 2, wherein the guide member is defined having a T-shaped structure adapted to be received in the slot having a step-profile corresponding to the T-shaped structure of the guide member.

4. The modular connector of claim 2, wherein the clamping mechanism comprises:
an actuating screw configured to be engaged with a threaded through-bore defined in a bottom wall of the second plate;
wherein the actuating screw comprises a tail end that abuts with a bottom face of the guide member, such that rotation of the actuating screw facilitates movement of the guide member along the slot and simultaneously facilitates movement of the at least one movable clamping feature.

5. The modular connector of claim 1, wherein the second plate is removably mounted on the first plate at a predefined angle, depending on structure of the bracket.

6. The modular connector] of claim 1, wherein the tool is a cylindrical tool, preferably a manual weld gun, and the robotic tool system comprises a control unit configured to be electrically connected to the tool to facilitate automated operation of the tool.

7. The modular connector of claim 1, wherein the at least two fixed clamping features and the at least one movable clamping feature have cylindrical structure defined with a concave profile at a centre portion of the respective clamping features to facilitate firm gripping of the tool.

8. The modular connector of claim 1, wherein the bracket is configured to be mounted on the first plate at multiple positions, depending on clearance requirements and operation to be performed by the tool; and
wherein the bracket is configured to connect the first plate with the second plate to form an L-shaped structure of the modular connector.

9. A robotic tool system, comprising:
a robotic arm configured to perform automated operations;
a modular connector configured to facilitate mounting of a tool on the robotic arm, the modular connector comprises:
a first plate;
a bracket configured to removably connect the first plate with a second plate, wherein the second plate comprises:
a clamping mechanism configured to facilitate clamping of the tool on the second plate of the modular connector; the clamping mechanism comprises:
at least two fixed clamping features and an at least one movable clamping feature positioned opposite to the at least two fixed clamping features, wherein the tool is adapted to be received between the at least two fixed clamping features and the at least one movable clamping feature, such that movement of the at least one movable clamping feature relative to the at least two fixed clamping features facilitates clamping of the tool on the second plate of the modular connector.

10. The robotic tool system of claim 9, wherein the clamping mechanism comprises:
an actuating screw configured to be engaged with a threaded through-bore defined in a bottom wall of the second plate; wherein the actuating screw comprises a tail end that abuts with a bottom face of the guide member, such that rotation of the actuating screw facilitates movement of the guide member along the slot and simultaneously facilitates movement of the at least one movable clamping feature.

11. The robotic tool system of claim 9, wherein the clamping mechanism comprises a guide member adapted to be slidably received in a slot defined in the second plate; and wherein the guide member is rigidly connected to the at least one movable clamping feature, such that movement of the guide member along the slot facilitates movement of the at least one movable clamping feature.

12. The robotic tool system of claim 11, wherein the guide member is defined having a T-shaped structure adapted to be received in the slot having a step-profile corresponding to the T-shaped structure of the guide member.

13. The robotic tool system of claim 9, wherein the second plate is removably mounted on the first plate at a predefined angle, depending on structure of the bracket.

14. The robotic tool system of claim 9, wherein the tool is a cylindrical tool, preferably a manual weld gun, and the robotic tool system comprises a control unit configured to be electrically connected to the tool to facilitate automated operation of the tool.

15. The robotic tool system of claim 9, wherein the at least two fixed clamping features and the at least one movable clamping feature have cylindrical structure defined with a concave profile at a centre portion of the respective clamping features to facilitate firm gripping of the tool.

16. The robotic tool system of claim 9, wherein the bracket is configured to be mounted on the first plate at multiple positions, depending on clearance requirements and operation to be performed by the tool; and
wherein the bracket is configured to connect the first plate with the second plate to form an L-shaped structure of the modular connector.
